(19) United States
(12) Patent Application Publication
(10) Pub. No.: US 2013/0120139 A1
(43) Pub. Date: May 16, 2013

(54) Locating system for locating and tracking an object

(71) Applicant: Chih Nong Chen, Taipei (TW)

(72) Inventor: Chih Nong Chen, Taipei (TW)

(73) Assignee: Ardi Technology Corporation

(21) Appl. No.: 13/373,491

(22) Filed: Nov. 16, 2011

(51) Int. Cl. G08B 1/08; G08B 21/00

(52) U.S. Cl. 340/539.1; 340/540

(57) ABSTRACT

A locating system includes a locating device having a control and processing module, a transmitting/receiving module electrically connected to the control and processing module and an antenna member for signal transmitting and receiving purposes, an alarm device electrically connected to the control and processing module for generating alarming signals, and a detecting device electrically connected to the control and processing module for detecting a motion of the locating device. The control and processing module includes a processor unit, a false alarm prevention unit coupled to the processor unit for preventing the false alarms from being occurred or generated.

### BACKGROUND OF THE INVENTION

1. Field of the Invention

The present invention relates to a locating system, and more particularly to a locating system including an improved structure for effectively or accurately locating and tracking an object, a person or the other parties to be searched or located and for preventing the false alarm from being occurred or generated.

2. Description of the Prior Art

Typical locating systems or locator devices comprise a system which may program or transmit an identification code number on a console keyboard to activate an encoder which transmits a number of coded pulses to a number of transceiver units located in the rooms of a building where surveillance is desired.

For example, U.S. Pat. No. 3,696,384 to Lester discloses one of the typical ultrasonic tracking and locating systems comprising a transducer in the transceiver transmits a coded, ultrasonic digital signal which is dispersed throughout the room, and portable pocket unit transceivers carried by persons to be located receive the transmitted ultrasonic digital signals and decide the signals to determine if they correspond to the pocket unit's identification code.

However, a number of false alarm signals may be generated inadvertently when both detecting and detected transceivers are moved together, or are not moved relative to each other.

U.S. Pat. No. 3,898,619 to Carsten et al. discloses another typical object location and identification system comprising a number of responding units, in combination with at least one interrogator-receiver unit, and each responding unit may be actuated by predetermined signals from the interrogator-receiver unit, or by means of its own separate power supply.

However, a number of false alarm signals may be generated inadvertently when the detecting and detected transceivers or the responding units or the interrogator-receiver units are moved together, or are not moved relative to each other.

U.S. Pat. No. 4,476,469 to Lander discloses a further typical object locator means for assisting in locating an object comprising a hand-held searcher including a short-range signal transmitter powered by an internal cell or battery and having electronic circuitry for generating an address signal when activated by switching means, and miniature locator including a transponder powered by an internal cell or battery and having electronic circuitry and signals received from the search.

However, a number of false alarm signals may be generated inadvertently when the hand-held searchers and the locators are moved together, or are not moved relative to each other.

U.S. Pat. No. 4,814,742 to Morita et al. discloses a further typical inquiry system for detecting a selected object comprising an answering device having its own identifying address which responds to a detecting command, and an answering device is provided on each object to be selected, and the detecting command is transmitted from a controller device.

However, a number of false alarm signals may be generated inadvertently when the controller devices and the answering devices are moved together, or are not moved relative to each other.

U.S. Pat. No. 5,742,233 to Hoffmann et al. discloses a still further typical personal security and tracking system comprising a portable signaling unit, a remote alarm switch device, a central dispatch station, and a wireless communication system such as a cellular or telephone system.

However, a number of false alarm signals may be generated inadvertently.

U.S. Pat. No. 6,326,901 to Gonzales discloses a still further typical tactile communication device comprising a series of sequential firing vibromechanical stimulators vibrating against the skin or other suitably tactile sensitive area or the wearer.

However, the signals transmitted or communicated to and from the sequential firing vibromechanical stimulators may be inaccurate, and a number of false alarm signals may be generated inadvertently between the transmitting devices and the receiving devices.

The present invention has arisen to mitigate and/or obviate the afore-described disadvantages of the conventional tracking or locator devices.

### SUMMARY OF THE INVENTION

The primary objective of the present invention is to provide a locating system including an improved structure for effectively or accurately locating and tracking an object, a person or the other parties to be searched or located and for preventing the false alarm or the like from being occurred or generated.

In accordance with one aspect of the invention, there is provided a locating system comprising a locating device including an antenna member, a control and processing module having a processor unit, a time sequence control unit electrically coupled to the processor unit, a false alarm prevention unit electrically coupled to the processor unit, and a data storage module electrically coupled to the processor unit, a transmitting/receiving module electrically connected to the control and processing module and electrically connected to the antenna member for signal transmitting and receiving purposes, an alarm device electrically connected to the control and processing module for generating alarming signals, and a detecting device electrically connected to the control and processing module for detecting a motion of the locating device.

The detecting device is selected from a vibration sensor, a motion sensor, a gravity G-sensor, a accelerometer, or a gyroscope. The data storage module of the control and processing module is selected from a random access memory or a flash memory.

The transmitting/receiving module is selected from a Wireless Local Area Network (WLAN) communication module, a Bluetooth communication module, a Zigbee communication module, or a Digital Radio Frequency communication module.

The data storage module of the control and processing module includes an alarm initializing setting and an alarm computing data, the alarm initializing setting is a constant, and the alarm computing data is variable.

The false alarm prevention unit of the control and processing module includes an alarm threshold comparative module, and/or a signal to distance computing module for determining the spacing distance between two separated locating devices.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a locating system in accordance with the present invention;

FIG. 2 is a plan schematic view of a locating device for the locating system;

FIG. 3 is another plan schematic view illustrating a control and processing module of the locating device of the locating system;

FIG. 4 is a block diagram illustrating the operation of the locating system; and

FIG. 5 is another block diagram illustrating the operation of the locating system.

### DETAILED DESCRIPTION OF THE PREFERRED EMBODIMENT

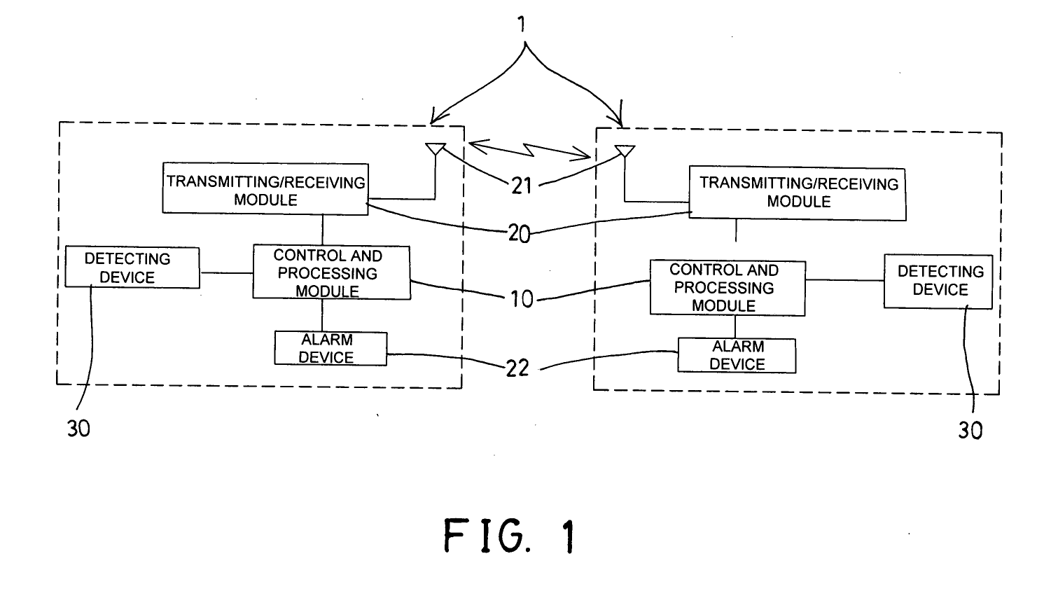

Referring to the drawings, and initially to FIG. 1, a locating system in accordance with the present invention comprises two or more locating devices 1 which may be transmitted and/or received or communicated with each other locating and tracking an object, a person or the like, for example, one of the locating devices 1 may be attached or mounted or secured or engaged into or with the object, person or the other parties to be searched or located, such as the mobile phone or portable phone, and the other locating device 1 may be carried with the person who owns the object or the mobile phone or portable phone or the searched party that is to be located, and the locating devices 1 may be communicated with each other.

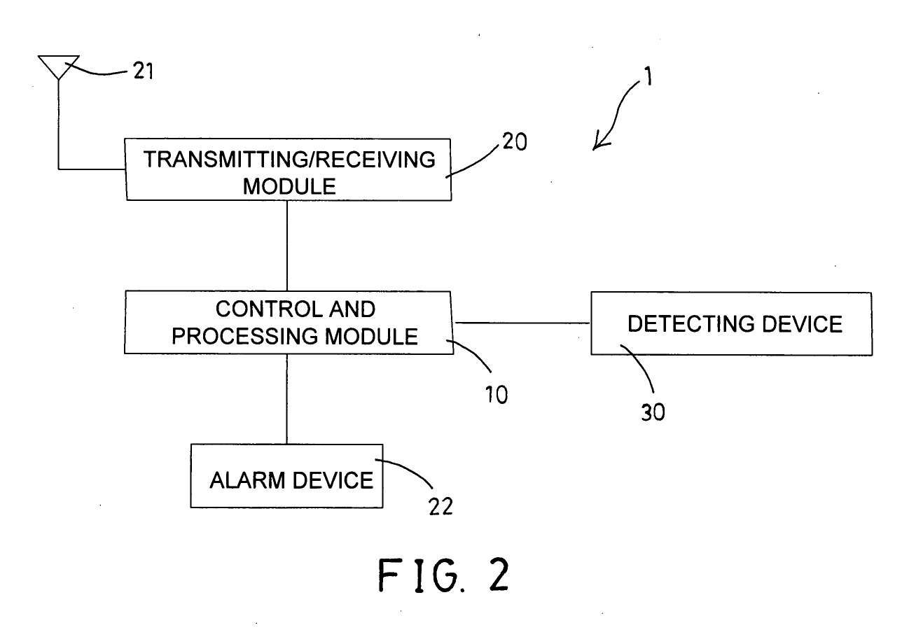

As shown in FIGS. 1 and 2, the locating devices 1 each include a control and processing module 10, a transmitting/receiving module 20 electrically connected or coupled to the control and processing module 10 and also electrically connected or coupled to an antenna member 21 which may be selected from various kinds of antenna members or devices for signal transmitting and/or receiving purposes, the transmitting/receiving module 20 may be selected from the Wireless Local Area Network (WLAN) communication module, such as IEEE 802.11 b/g/n, the Bluetooth communication module, the Zigbee communication module, the Digital Radio Frequency communication module, or the like. An alarm device 22, such as a buzzer, a light generating device or the like is electrically connected or coupled to the control and processing module 10 for generating alarming sounds or lights or signals or the like.

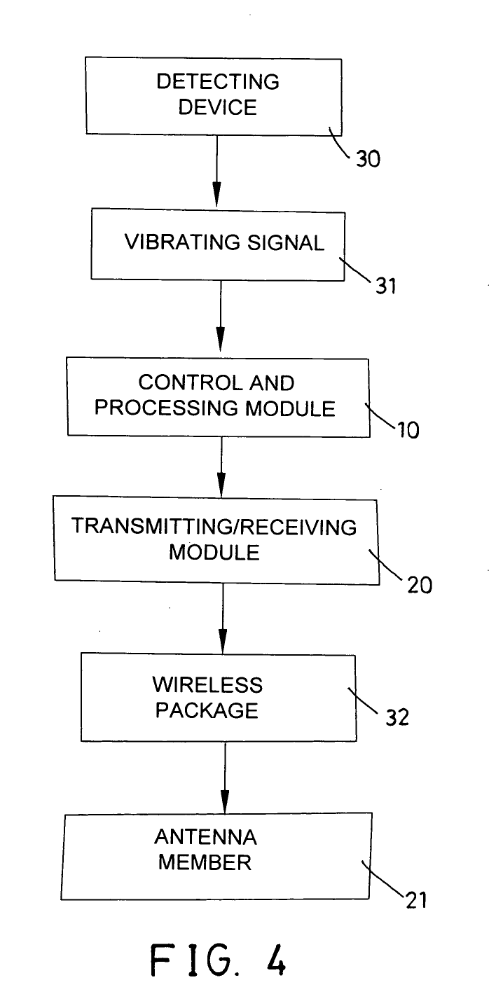

A sensing or detecting device 30 is further provided and also electrically connected or coupled to the control and processing module 10 for generating and sending the sensed or detected signals to the control and processing module 10, and may be selected from the vibration sensor, the motion sensor, the gravity G-sensor, the accelerometer, the gyroscope, or the like, for detecting the motion or the movement of the locating devices 1 and for generating the detected vibration or vibrating signals 31 (FIG. 4) or the like, and for sending the detected vibration signals to the control and processing module 10 which may receive and treat or process the detected vibration signals to actuate the transmitting/receiving module 20 to generate an information or wireless package 32 (FIG. 4) that may then be sent or transmitted to the other locating devices 1 with the antenna member 21.

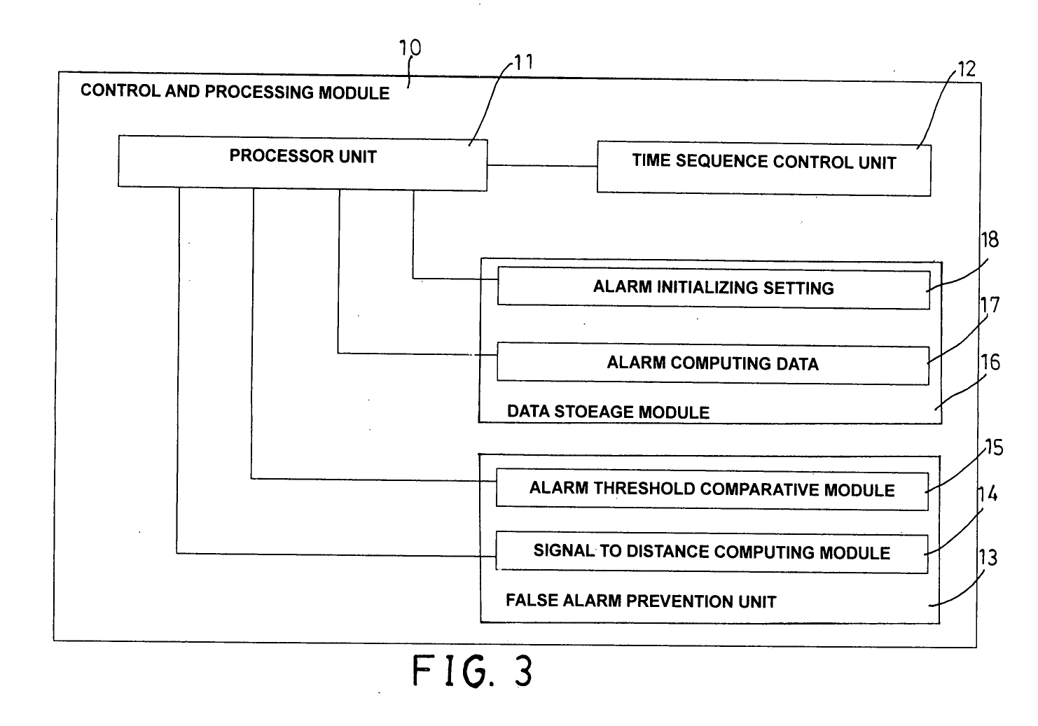

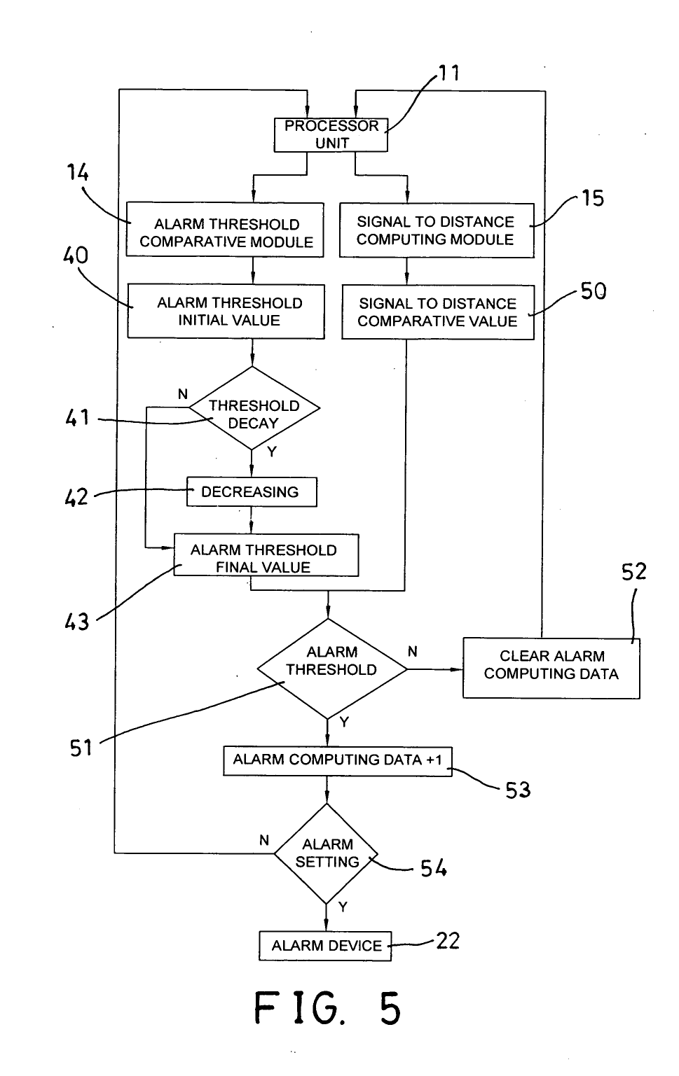

As shown in FIG. 3, the control and processing module 10 includes a processor unit 11, a time sequence control unit 12 electrically connected or coupled to the processor unit 11 for timing controlling purposes, a false alarm prevention unit 13 having an alarm threshold comparative module 14 and a signal to distance computing module 15 electrically connected or coupled to the processor unit 11 for preventing false alarms from being generated, the alarm threshold comparative module 14 may be provided for generating an alarm threshold initial value 40 (FIG. 5), and the signal to distance computing module 15 may be provided for generating a signal to distance comparative value 50 (FIG. 5) and for preventing false alarms from being generated.

The control and processing module 10 further includes a data storage module 16 for storing various data or information and electrically connected or coupled to the processor unit 11, and the data storage module 16 includes an alarm initializing setting 17 and an alarm computing data 18. The data storage module 16 may be selected from the random access memory, the flash memory or the like for memorizing or storing various data or information, and the stored data or information may be provided for determining when to generate the alarm signals. The alarm initializing setting 17 is a constant that may not be changed or modified, and the alarm computing data 18 is a variable value and includes an initial value: zero (0).

In operation, one or a first of the locating devices 1 may be attached or mounted or secured or engaged into or with the object, person or the other parties to be searched or located, such as the mobile phone or portable phone, and the other or the second locating device 1 may be carried with the person who owns the object or the mobile phone or portable phone or the searched party that is to be located. When the first locating device 1 is moved, as shown in FIG. 4, the detecting device 30 may detect the motion or the movement of the first locating device 1 and may generate the detected vibration or vibrating signals 31 or the like, and may then send the detected vibration signals 31 to the control and processing module 10 which may receive and treat or process the detected vibration signals 31 to actuate the transmitting/receiving module 20 to generate an information or wireless package 32 that may then be sent or transmitted to the other or second locating device 1 with the antenna member 21.

Similarly, the detecting device 30 of the other or second locating device 1 may also detect and generate and send the vibration or vibrating signals 31 to the control and processing module 10 which may also actuate the transmitting/receiving module 20 to generate an information or wireless package 32 that may then be sent or transmitted to the other locating devices 1 with the antenna member 21. When the antenna member 21 and the transmitting/receiving module 20 of the other or second locating device 1 receives the wireless package 32 from the first locating device 1, the transmitting/receiving module 20 may convert the received signals from analog or digital to digital or analog signals which may then be sent to the control and processing module 10 of the other or second locating device 1.

As shown in FIG. 5, the processor unit 11 of the control and processing module 10 of the other or second locating device 1 may receive and treat or process the detected or received signals and may send the treated or processed signals to the signal to distance computing module 15 of the false alarm prevention unit 13 which may then be provided for generating a signal to distance comparative value 50 with a relation or equation that the strength of the wireless signals and the square of the distance are in inverse ratio, in order to compute or generate or determine the spacing distance between the two separated first and second locating devices 1 and for determining whether to generate the alarm signals or not and for preventing false alarms from being generated.

The treated or processed signals from the processor unit 11 of the control and processing module 10 of the other or second locating device 1 may also be sent to the alarm threshold comparative module 14 of the false alarm prevention unit 13, and the alarm threshold comparative module 14 may then be provided for generating an alarm threshold initial value 40, and the alarm threshold comparative module 14 and the signal to distance computing module 15 of the false alarm prevention unit 13 and the processor unit 11 may be worked together to determine whether to generate the alarm signals or not and to prevent the false alarms from being generated.

For example, as also shown in FIG. 5, the alarm threshold comparative module 14 and the signal to distance computing module 15 of the false alarm prevention unit 13 and the processor unit 11 may be worked together to determine whether the decay or decreasing of the alarm threshold is occurred or not in the process 41, and the alarm threshold may be selectively reduced or decreased according to various kinds of conditions or situations in the process 42 in order to obtain the alarm threshold final value in the process 43, and thus to determine whether the conditions or situations are required to generate the alarm signals or not, and thus to prevent the false alarms from being generated.

For example, when both the first and the second locating devices 1 are moved, or are not moved, the alarm threshold final value may be decreased and may be moved back to the process 41, and again to determine whether the decay or decreasing of the alarm threshold is occurred or not. Simultaneously, the signal to distance computing module 15 of the false alarm prevention unit 13 may compute or generate or determine the spacing distance between the two separated first and second locating devices 1 and may determine whether the two separated first and second locating devices 1 are too far apart from each other. No further processes will be processed if or when the two separated first and second locating devices 1 are not too far apart from each other.

When only one of the locating devices 1 is moved and when the two separated first and second locating devices 1 are moved apart from each other, an alarm threshold comparing process 51 will be proceeded to compare whether the signal to distance comparative value 50 is greater than the alarm threshold final value (43) or not, the alarm computing data 18 in the data storage module 16 that is a variable value and that includes an initial value: zero (0) will then be cleared in the process 52 when the signal to distance comparative value 50 is greater than the alarm threshold final value (43), and the alarm computing data 18 in the data storage module 16 will be increased with one (1) in the process 53 when the signal to distance comparative value 50 is not greater than the alarm threshold final value (43).

The variable alarm computing data 18 in the data storage module 16 will then be compared with the alarm initializing setting 17 of the data storage module 16 in the process 54, if the variable alarm computing data 18 in the data storage module 16 is not equal to the alarm initializing setting 17 of the data storage module 16, the alarm device 22 will not be actuated or energized or operated. However, when the variable alarm computing data 18 in the data storage module 16 is equal to or greater than the alarm initializing setting 17 of the data storage module 16, the alarm device 22 will be actuated or energized or operated to generate the alarming sounds or lights or signals or the like.

For example, when the first and the second locating devices 1 are moved away from each other for a predetermined or selected distance, or when the mobile phone or portable phone has been moved away from the user for a predetermined or selected distance, the variable alarm computing data 18 in the data storage module 16 will be continuously increased with one (1) each time, until the variable alarm computing data 18 in the data storage module 16 is equal to or greater than the alarm initializing setting 17 of the data storage module 16, and the alarm device 22 will then be actuated or energized or operated to generate the alarming sounds or lights or signals or the like for easily tracking or locating the object, the person or the other parties to be searched or located. The second locating device 1 may also generate and send the signals to the first locating device 1 and to actuate or energize or operate the alarm device 22 of the first locating device 1 to generate the alarming sounds or lights or signals or the like.

It is to be noted that the detecting device 30 may be selected from the vibration sensor, the motion sensor, the gravity G-sensor, the accelerometer, the gyroscope, or the like, and may accurately detect the motion or the movement of the locating devices 1 and may generate and send the detected vibration or vibrating signals 31 from or to or between the locating devices 1, and may accurately generate the alarm signals to easily and quickly track and locate the object, the person or the other parties to be searched or located, and may be provided for preventing the false alarms from being generated.

Accordingly, the locating system in accordance with the present invention includes an improved structure for effectively or accurately locating and tracking an object, a person or the other parties to be searched or located and for preventing the false alarm or the like from being occurred or generated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A locating system comprising:
a locating device including:
an antenna member,
a control and processing module having a processor unit, a time sequence control unit electrically coupled to said processor unit, a false alarm prevention unit electrically coupled to said processor unit, and a data storage module electrically coupled to said processor unit,
a transmitting/receiving module electrically connected to said control and processing module and electrically connected to said antenna member for signal transmitting and receiving purposes,
an alarm device electrically connected to said control and processing module for generating alarming signals, and
a detecting device electrically connected to said control and processing module for detecting a motion of said locating device.

2. The locating system as claimed in claim 1, wherein said detecting device is selected from a vibration sensor, a motion sensor, a gravity G-sensor, a accelerometer, or a gyroscope.

3. The locating system as claimed in claim 1, wherein said transmitting/receiving module is selected from a Wireless Local Area Network (WLAN) communication module, a Bluetooth communication module, a Zigbee communication module, or a Digital Radio Frequency communication module.

4. The locating system as claimed in claim 1, wherein said data storage module of said control and processing module is selected from a random access memory or a flash memory.

5. The locating system as claimed in claim 1, wherein said data storage module of said control and processing module includes an alarm initializing setting and an alarm computing data, the alarm initializing setting is a constant, and the alarm computing data is variable.

6. The locating system as claimed in claim 1, wherein said false alarm prevention unit of said control and processing module includes an alarm threshold comparative module.

7. The locating system as claimed in claim 1, wherein said false alarm prevention unit of said control and processing module includes a signal to distance computing module.
